(19) United States
(12) Patent Application Publication
(10) Pub. No.: US 2026/0103170 A1
(43) Pub. Date: Apr. 16, 2026

(54) Vehicle Leveling System

(71) Applicant: Steiner Enterprises, Lafayette, IN (US)

(72) Inventors: Thomas P. Hicks, Lafayette, IN (US); Donald E. DeWitt, Syracuse, IN (US); Joshua E. DeWitt, Westfield, IN (US); Christopher R. Laudenschlager, Lafayette, IN (US)

(21) Appl. No.: 19/355,577

(22) Filed: Oct. 10, 2025

Related U.S. Application Data
(60) Provisional application No. 63/706,448, filed on Oct. 11, 2024.

(51) Int. Cl. B60S 9/12; F15B 13/04; F15B 13/044; F15B 15/14; F15B 19/00; G01G 19/10

(52) U.S. Cl. CPC B60S 9/12; F15B 13/0401; F15B 13/044; F15B 15/1447; F15B 19/00; G01G 19/10; F15B 2211/327

(57) ABSTRACT

A leveling system for a vehicle includes a plurality of hydraulic jacks with ground-engaging plates mounted to the frame of the vehicle. A pressure transducer is provided to measure the fluid pressure in each individual jack. A directional valve controls the fluid flow between the extension pressure line and the retraction pressure line of the plurality of jacks, and a source of pressurized fluid and a fluid tank. A directional valve array includes a directional valve for each jack that opens or closes the extension pressure line for that jack. Pitch and roll sensors measure the amount of tilt in the pitch and roll directions of the frame. A controller with a microprocessor control unit (MCU) reads data from the sensors to first determine if the frame of the vehicle is twisted, and then to sequentially determine which single jack to extend to reduce the twist, until the twist in the frame has been reduced to an acceptable amount. The MCU then determines which pair of jacks to extend to reduce the amount of pitch and roll remaining in the frame after the twist has been removed.

### PRIORITY CLAIM

This application claims priority to U.S. Provisional Application No. 63/706,448, filed on Oct. 11, 2024, the entire disclosure of which is incorporated herein by reference.

### BACKGROUND

This disclosure concerns a leveling system for a vehicle, such as a recreational vehicle.

Vehicles, such as recreational vehicles (RVs) and fifth-wheel trailers, often require systems for leveling the frame of the vehicle when the vehicle is stationary. For instance, since an RV serves as a dwelling it is imperative that the RV be as level as possible for the convenience and safety of the RV occupants. FIG. 1 shows a fifth-wheel trailer with a frame F and wheels W that support the living quarters of the fifth-wheel. It should be appreciated that the system shown in FIG. 1 can be implemented in the coach towing the trailer and in an RV. At least three jacks A1-A4 are provided adjacent corresponding wheels that are capable of raising or lowering the particular corner of the frame F. At least one sensor S is provided at different locations on the frame to determine the amount of tilt and/or twist at a particular location on the frame. The sensors can be positioned and configured to detect tilt in the pitch direction, in which the vehicle tilts from the front to the back of the vehicle, and in the roll direction, in which the vehicle tilts from one side to the other. The jacks A1-A4 can include jacks, whether hydraulic, pneumatic or electric, configured to lower ground-engaging plates P to engage the ground, then to raise or lower the associated corner of the frame, and eventually to raise the plates P when the vehicle is ready to be driven.

### SUMMARY

A leveling system for a vehicle, such as a fifth-wheel trailer, an RV or a coach, includes a plurality of hydraulic or pneumatic jacks mounted to the frame. In one embodiment, a jack is at each of the four corners of the frame of the vehicle. In other embodiments, a jack is provided at two corners at one end of the trailer, with a third jack in the middle of the opposite end of the trailer. A pressure transducer is provided to measure the fluid pressure in each individual jack. A directional valve controls the fluid flow between the extension pressure line and the retraction pressure line of the plurality of jacks, and a source of pressurized fluid and a fluid tank. A directional valve array includes a directional valve for each jack that opens or closes the extension pressure line for that jack.

Pitch and roll sensors measure the amount of tilt in the pitch and roll directions of the frame. A controller with a microprocessor control unit (MCU) reads data from the sensors to first determine if the frame of the vehicle is twisted, and then to sequentially determine which single jack to extend to reduce the twist, until the twist in the frame has been reduced to an acceptable amount. The MCU then determines which pair of jacks to extend to reduce the amount of pitch and roll remaining in the frame after the twist has been removed.

The MCU is configured to measure the pressure individually in each jack. The MCU controls the directional valves so that a single pressure transducer can measure the pressure in any given jack. The measured pressure can be used to determine when a jack has been fully extended or retracted, when the ground-engaging plate of a jack has contacted the ground, and when a fault condition arises in the fluid system.

The MCU can be operable to automatically lift the front end of a fifth-wheel trailer to allow disengagement and re-engagement of the trailer from a towing vehicle. In another embodiment, the MCU can control the operation of intermediate jacks of a jack system for the trailer.

### BRIEF DESCRIPTION OF THE DRAWINGS

FIG. 1 is diagram of a frame of a vehicle with a plurality of jacks for leveling the frame.

FIG. 2A is diagram of a system of jacks for leveling the frame shown in FIG. 1.

FIG. 2B is diagram of the valve assembly for controlling the jacks shown in FIG. 2A.

FIG. 2C is diagram of part of the valve assembly of FIG. 2B, modified to incorporate pressure transducers for each jack.

FIG. 3 is a circuit diagram for a safety shut-off feature for the valve assembly of FIG. 2B.

FIG. 4 is a flowchart of a process for automatically leveling a fifth-wheel trailer.

FIG. 5 is a flowchart of a process for automatically leveling a recreational vehicle (RV).

FIG. 6A is a flowchart of a process for automatically leveling a coach.

FIG. 6B is a segment of the flowchart of FIG. 6A, modified according to a further embodiment.

### DETAILED DESCRIPTION

For the present invention, the jacks are pneumatic or hydraulic and include pressure transducers to measure the pressure in a hydraulic cylinder at each jack and to detect when the hydraulic cylinder is fully retracted.

The pressure transducers are an important element to the leveling system of the present disclosure. In particular, the system uses the transducer to know much more about the system than other systems, including touch down detection, retraction detection, low/no pressure situations, full extension detection, weight estimation and more. We will utilize at least one transducer per system but possibly more.

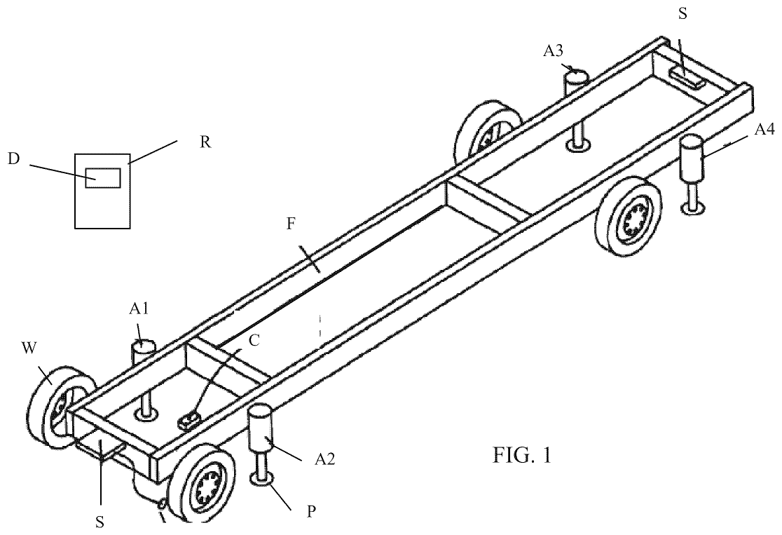

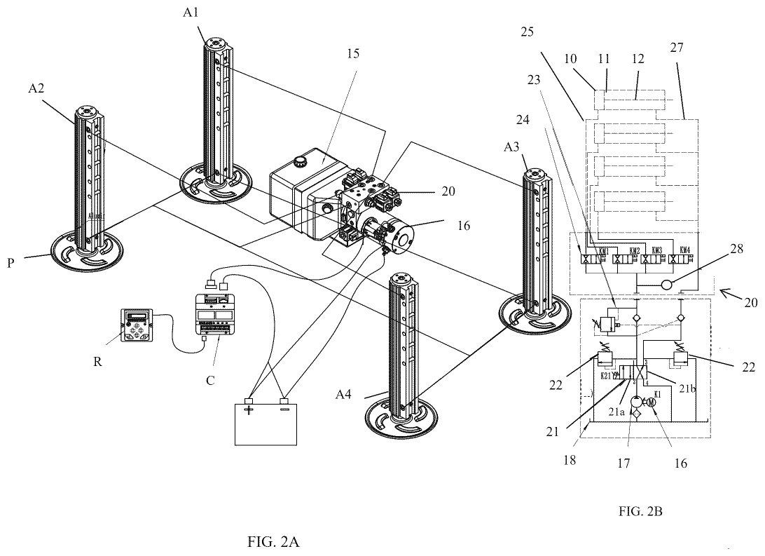

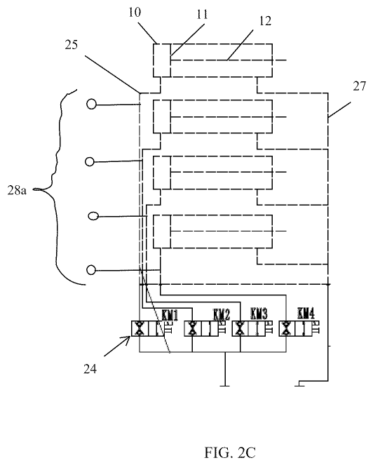

According to the present invention, the jacks A1-A4 are controlled by a common controller C that includes a microprocessor operable to execute software to activate the jacks to level the vehicle. A remote device R with a display D can communicate with the controller C and can be used to control operation of the software during a leveling process. The controller C is configured to send activation signals to relays used to control valves to increase or reduce pressure in the jack cylinders. FIG. 2A shows a representation of the system of jacks A1-A4 for leveling the frame shown in FIG. 1. In the present disclosure, the jacks include conventional pneumatic or hydraulic cylinders, that include a fluid-filled cylinder 10, a piston 11 driven by fluid pressure within the cylinder, and a rod 12 attached between the piston and the ground-engaging plate P of each jack. A hydraulic unit 15 includes a pump 17 driven by motor 16 to draw fluid from a tank 18 to feed to the cylinders 10 of each jack. According to the auto-leveling system and method of the present disclosure, sensors S are provided at the front and the rear of the vehicle to measure both pitch and roll at the front and rear. This data allows the system to determine if the frame of the vehicle is twisted.

A valve assembly 20 shown in FIG. 2B controls the direction and amount of fluid for each cylinder. In particular, the valve assembly controls the fluid provided on an extension pressure line 25 and on a retraction pressure line 27 for each cylinder. Pressurized fluid on the extension pressure line 25 causes the piston 11 to extend the rod 12, and thus extend the ground-engaging plate P of the particular jack. Likewise, pressurized fluid on the retraction pressure line 27 causes the piston 11 to withdraw the rod 12, and thus retract the ground-engaging plate P of the particular jack. Pressurized fluid from the pump 17 is directed by a solenoid directional valve 21 to either the extension pressure line 25 in position 21a, or the retraction pressure line 27 in position 21b. In each position 21a, 21b the non-pressurized line is opened to the tank 18. Each line includes a relief valve 22 that dumps the fluid into the tank 20 when an over-pressure condition arises. In one embodiment, the relief pressure for the extension pressure line is greater than the relief pressure for the retraction pressure line. In a specific embodiment, the relief pressures are 2850 psi for line 25 and 2650 psi for line 27. A counterbalance cartridge valve 23 is disposed in the extension pressure line 25 to maintain the pressure within each jack, which is critical when the jacks are supporting the vehicle. The fluid in the extension pressure line passes to a solenoid directional valve array 24 with a solenoid valve KM1-KM4 dedicated to a corresponding jack A1-A4. The directional valves in the array 24 are on-off valves that control whether pressurized fluid is provided to the cylinder 10 of the respective jack.

The controller C includes a microprocessor control unit (MCU) that includes software and/or firmware configured and operable to send a control to the motor 16 to drive the pump 17, controlling the speed of the motor to control the fluid pressure generated by the pump. The MCU is also configured and operable to send control signals to the solenoid for each of the directional valves 21 and 24 to move the respective valve between an open and a closed condition. The MCU thus controls when the directional valve 21 is in a first position 21a to provide pressurized fluid to the cylinders 10 of the jacks on the extension pressure line 25, and when the directional valve 21 is in a second position 21b in which pressurized fluid is provided to the retraction pressure line 27. The MCU also controls the directional valves KM1-KM4 in the valve array 24 to determine the sequence of operation of each jack A1-A4 during a leveling process described herein. The MCU and/or controller C further includes storage for storing information regarding the frame of the vehicle/trailer on which the jacks and sensors are mounted, as well as information about the jacks, such as the response of the jack of the jack to the application of pressurized fluid to the jack. This information is used to determine how much a particular corner, end or side of the frame needs to be raised to address a twist or tilt condition, as well as how long a particular jack needs to be operated to achieve the desired result.

In one aspect of the present disclosure, a pressure transducer 28 is provided at the inlet to the valve array 24. The pressure transducer 28 provides a signal to the MCU indicative of the fluid pressure within the extension pressure line 25 that can be evaluated by the MCU to determine the state of any of the jacks A1-A4. To identify the fluid pressure in any particular jack, such as A1, the MCU opens the directional valve corresponding to the jack, such as KM1, keeping the other valves closed. The MCU can cycle through each of the remaining valves KM2-KM4 to measure the pressure in the remaining jacks A2-A4. In one mode, the MCU is configured to compare the signal from the transducer 28 to a lower pressure threshold value indicative of the jack being fully retracted. The MCU is also configured to compare the fluid pressure in the extension pressure line 25 with stored values indicative of full extension of the jacks, initial touch-down of a jack during extension, the advent of retraction movement of the jacks and pressure failure conditions, such as low or no pressure in the line 25.

The pressure value obtained by the transducer 28 can also be used by the MCU to determine the weight of the vehicle. In this mode, the jacks A1-A4 are operated to lift the vehicle off the ground so that the entire weight of the vehicle is borne by the jacks. The jacks are preferably first operated until the ground-engaging plates of each jack is in contact with the ground, as determined by the MCU. When it is verified that all plates are in contact with the ground, the MCU operates the jacks for a predetermined time sufficient to lift the vehicle off the ground. Preferably, the jacks are operated in unison to avoid inducing any twist to the vehicle frame. The weight of the vehicle corresponds to the sum of the pressure values for the jacks multiplied by the surface area of the respective ground-engaging plate P of the jack. It can be appreciated that in some instances the surface area of the ground-engaging plates may differ among the jacks. Thus, the MCU can access stored data regarding the structure of each of the jacks when calculating the total weight of the vehicle.

In an alternative embodiment shown in FIG. 2C, a pressure transducer array 28a can include a separate transducer incorporated into the extension pressure line 25 of each jack A1-A4. The MCU can evaluate the pressure values from each of the transducers in the array 28a by opening the corresponding directional valve KM1-KM4 to determine full retraction, full extension, initial touch-down, initial retraction and failure conditions of each jack individually.

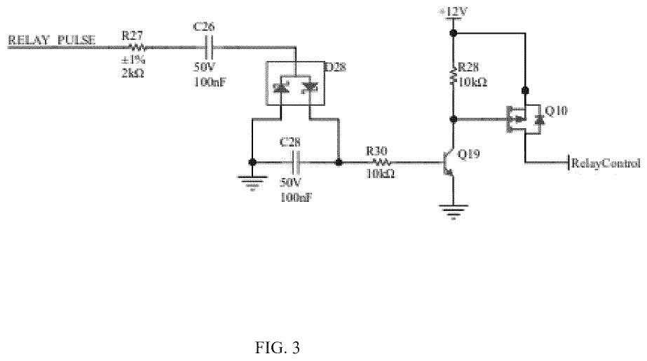

In one feature, a safety shut-off is provided in the controller C that requires the microprocessor MCU of the controller C to pulse a pin within a specific frequency range to provide power to the solenoids for the directional valves 21 and 24. The directional valve 21 is biased to the second condition 21b in which pressure is applied to the retraction pressure line 27. Likewise, the directional valves in the array 24 are biased to the off configuration preventing pressurized fluid from being fed to the extension pressure line 25 for the cylinder 10 of each jack A1-A4. The solenoid, or relay, for each directional valve 21, 24 requires an activation signal from the MCU. The electronics/circuitry for providing electrical power to the solenoids is configured to require a “Relay Control” signal. The system of the present disclosure incorporates the circuit shown in FIG. 3 that receives a “RELAY PULSE” signal from the MCU. If this signal is not present, the RELAY CONTROL signal will be null, preventing electrical power from being provided to the solenoids. Thus, in the event the controller C or MCU is destroyed or damaged the loss of electrical power to the solenoids will prevent them from being stuck in their “on” configuration, which would otherwise result in some undesirable actions of the system that can potentially be harmful to the system or to bystanders. The MCU is configured to continuously generate the RELAY PULSE signal as long as it is properly functioning. In another feature, the MCU can receive a signal from the vehicle parking brake indicating that the parking brake has been activated by the user. As long as this parking brake activation signal is received by the MCU, the MCU will generate the RELAY PULSE signal. This feature prevents activation of the leveling system when the parking brake is not in use. The MCU can receive other signals from the vehicle that verify that the vehicle is properly configured to activate the leveling system, such as ensuring the vehicle engine is off, verifying that the vehicle is not moving or verifying that the vehicle is not on an attitude that is unsafe. With respect to vehicle movement, the MCU can receive a signal from an accelerometer on-board the vehicle. With respect to the attitude of the vehicle, it can be appreciated that if the vehicle is on a significant slope, raising one side of the vehicle can be risky. The tilt sensors S shown in FIG. 1, or other tilt sensors associated with the vehicle, can be surveyed to determine if the tilt angle exceeds a threshold, in which case the MCU does not generate the RELAY PULSE signal and the jacks cannot be activated.

In another feature, firmware in the controller C can include a current detection circuit that measures the current going through the solenoid valves that control fluid flow to the jack cylinders. This feature provides the ability to detect when a valve is not attached properly or when a cable is shorted. In the event a valve is not attached and an attempt is made to run it, the current detection circuit will detect it the fault and prevent the pump from running and dead heading (i.e., running a pump with no path for fluid to travel resulting in a pressure spike that can damage hoses, joints, or other hardware). The short circuit detection protects the electronics from destruction.

In another feature, an onboard accelerometer is provided in the vehicle to determine if the vehicle is in motion. When this happens the system with be locked out of all operations and will not be able to activate any of the jacks.

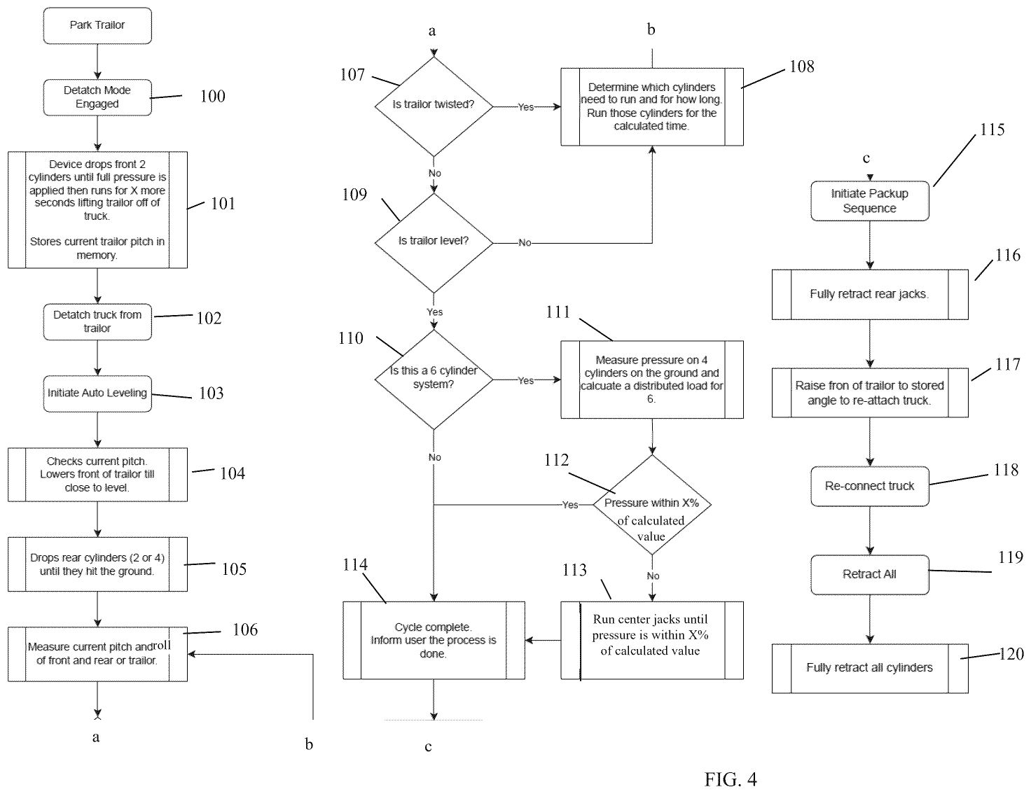

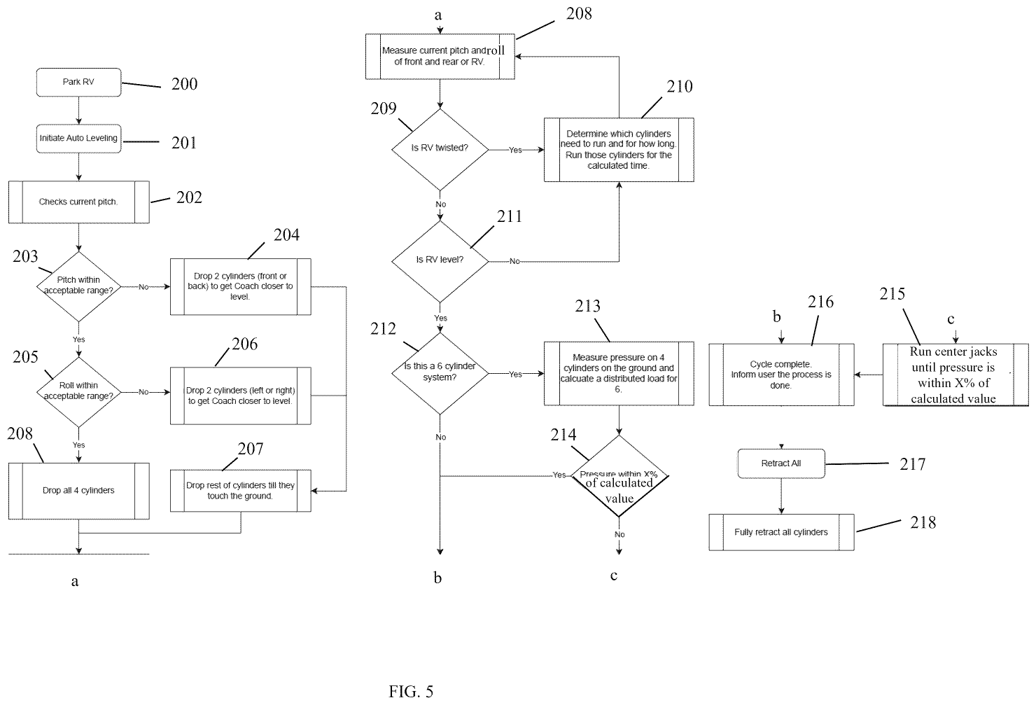

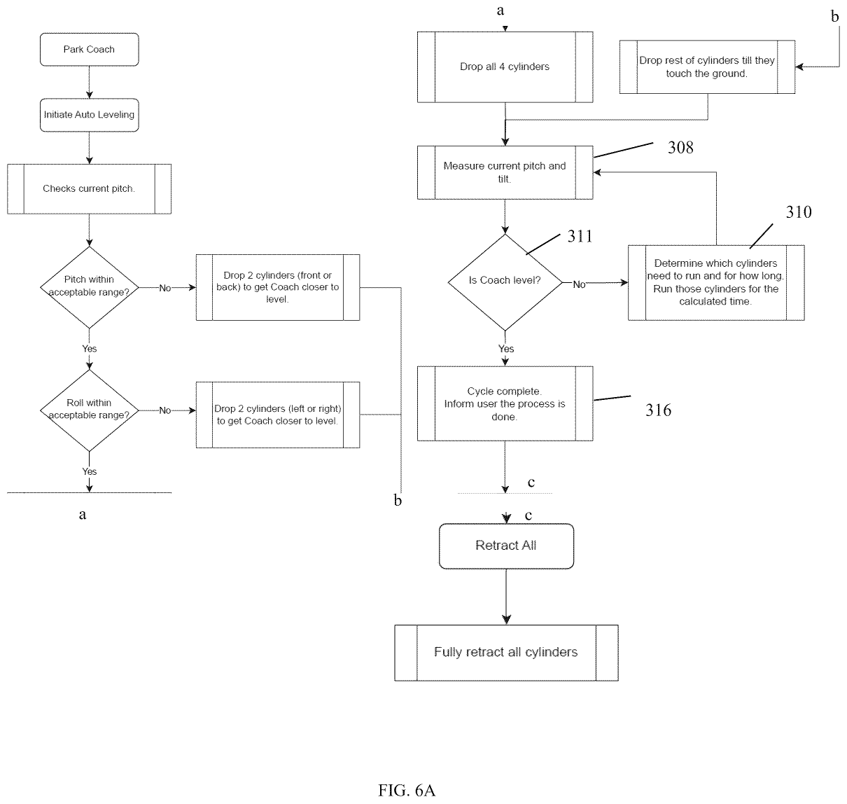

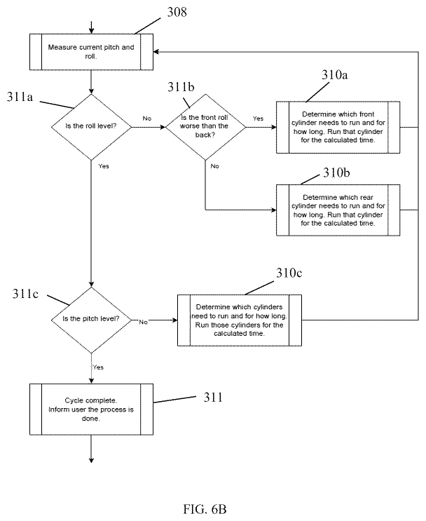

The microprocessor of the controller C is operable to execute software to perform automatic leveling operations for three types of vehicles. In accordance with the valve assembly 20, the leveling operation only involves extending the piston rod 12 of the jacks A1-A4 based on controlled application of fluid under pressure to the extension pressure lines 25. Retraction of the piston rods and ground-engaging plates P occurs in unison for all of the jacks. The sequence of actions performed by the user and by the software to level a fifth-wheel trailer is shown in FIG. 4. The sequence of actions performed by the user and by the software to level a recreational vehicle is shown in FIG. 5. The sequence of actions performed by the user and by the software to level a coach is shown in FIG. 6. In each case, the user activates the automatic leveling sequence through the remote device R or the controller C.

A fifth-wheel trailer is attached to a pulling vehicle, such as a pick-up truck, by a trailer hitch. Thus, the first step 100 in the self-leveling sequence for a fifth wheel shown in FIG. 4 is that the operator activates the “detach mode” of operation. When so activated by the user, the controller, and particularly the MCU, actuates the front two jacks A1, A2 in step 101 until the pressure transducer 28 (or transducer array 28a) senses that the full pressure has been applied to the extension pressure line 25 for the two front jacks. The MCU then directs the two front jacks to continue lifting the vehicle for a predetermined time calibrated to ensure that the hitch components of the trailer have disengaged the hitch components of the towing vehicle. The MCU then stores the data from the sensors S corresponding to the current pitch of the trailer (pitch=tilt angle of the trailer from the front to the back), since that pitch value corresponds to how much the front of the trailer needs to be raised to accept the trailer hitch of the towing vehicle. The user detaches the trailer from the towing vehicle in step 102 and moves the towing vehicle from the trailer. The user initiates the auto-leveling sequence in step 103 using the remote device R or controller C.

Since the front of the trailer had been raised to detach the trailer hitch, the first step 104 in the auto-leveling sequence is to lower the front of the trailer until the pitch, as determined by the sensors S, is near zero. Thus, in this step, the MCU of the controller controls the directional valves 24, namely KM1, KM2, to move to the “ON” configuration, leaving the other two valves for the rear jacks in the “OFF” configuration, and then controls the directional valve 21 to move the vale to the second configuration 21b that applies pressure to the retract pressure line 27. Since the two jacks A3, A4 are inactive, all of the fluid pressure will be directed to the two active jacks A1, A2 to lift the pistons 11 of the respective cylinders 10, thereby lowering the front end of the trailer. Once the desired pitch angle (preferably 0 degrees) is reached, the MCU stops the motor 16 and closes the directional valves KM1, KM2.

Since the front jacks are already in contact with the ground, the next step 105 is to lower the rear jacks A3, A4 until they contact the ground. This determination can be made using the pressure transducer 28 or transducer array 28a and valve array 24, as described above. With all of the ground-engaging plates P of the jacks A1-A4 in contact with the ground, the MCU surveys the sensors S to determine the pitch and roll of the trailer in step 106, and determines whether the trailer is twisted in step 107 by comparing the roll angle between the front and rear of the trailer. If the difference in the roll angle between front and rear exceeds a predetermined threshold (which could be 0°) the MCU determines which jack needs to be extended in step 108 to raise a particular corner of the trailer. The MCU calculates how long that particular jack needs to run to reduce the twist based on how far the piston rod 12 for that jack needs to be extended, which ultimately raises the particular corner of the fifth wheel trailer. The identified jack is activated for the calculated time and the MCU returns to step 106 to measure the current pitch and roll of the trailer, followed by the determination of the trailer is still twisted in step 107. Once the MCU determines that the trailer is not twisted, control passes to step 109 in which the MCU checks to determine if the trailer is level, meaning that the sensors S do not identify any tilt in the pitch and roll directions that exceed a predetermined angle corresponding to a condition in which the trailer is level within a predetermined angular range. If the MCU detects that the trailer is not level, control returns to step 108 where the MCU again determines which jack needs to be extended further to achieve the level condition.

It is noted that in this sequence of steps the MCU can initially determine if any of the tilt angles (pitch and/or roll) are excessive. An excessive angle is one in which correction requires extending one or more jacks beyond a safe distance. This can occur when the amount of jack extension required to reduce the particular tilt angle will result in the jack lifting the vehicle wheels off the ground. This can also occur if the required amount of extension will exceed the maximum extension capability of the jack. The MCU can thus compare a tilt angle to a predetermined angle or can compare the calculated jack extension exceeds a predetermined distance. In either case, the MCU can terminate the leveling sequence and issue a warning to the user.

For a trailer having only four jacks, the process advances to step 114 in which the controller C informs the user, such as through the remote device R, that the trailer is level. On the other hand, some trailers include two additional intermediate jacks in the center of the trailer, particularly if the trailer is long. In this case, the query in step 110 is effectively answered by trailer information stored in a memory of the MCU or controller C. In step 111 the pressure of the four jacks at the corners of the trailer that are already in contact with the ground is measured. The MCU then calculates what pressure would be applied to each of six jacks to distribute the weight of the fifth wheel trailer among the six jacks. The MCU then measures the pressure in the intermediate jacks and determines, in step 112, whether that pressure is within a predetermined range of the pressure for the 6-jack distributed load in in the prior step. In one embodiment, the MCU defines the range as ±X % of the calculated pressure. If the pressure in the center jacks is not within the predetermined range, then in step 113 the MCU opens the associated directional valves in the valve array 24 to feed pressurized fluid to the cylinders of the intermediate jacks until the pressure in the intermediate jacks falls within the predetermined range of the calculated pressure from step 111.

Steps 115-120 are applied when the user wants to engage the fifth wheel trailer to the towing vehicle. The rear jacks are retracted first in step 116 so that the trailer is supported by the rear wheels of the trailer. Then, then pressured fluid is applied to the extension pressure lines 25 of the front jacks A1-A2 until the trailer is at the pitch angle stored in step 101 at the beginning of the sequence of steps to detach the trailer from the trailer hitch. The user reconnects the towing vehicle to the trailer in step 118 and then issues a command to the MCU to retract the jacks in step 119. The MCU then applies fluid pressure to the retraction pressure line 27 to retract the piston rods 12 of all of the jacks A1-A4 in step 120.

The auto-leveling sequence for an RV is shown in the flowchart of FIG. 5. In the first step 201, the user parks the RV (step 200), which requires setting the parking brake and shutting off the engine due to the safety shut-off feature described above. The user then requests the auto-leveling process in step 201 using the remote device R or the controller C. In step 202 the MCU interrogates the sensors S to determine the amount of pitch and determine whether the pitch angle is within a predetermined range step 203. If not, then in step 204 the MCU determines whether the two front or the two rear jacks need to be extended to raise the front or the rear of the RV to reduce the pitch angle. Steps 205 and 206 perform a similar operation for the roll angle, in this case determining whether to activate the jacks on the left side or the right side of the RV to raise the respective side. Steps 204-206 are performed to ensure that the vehicle is not lifted of the ground during the auto-leveling process. It is understood that the RV is primarily supported by its own wheels W and suspension system. The goal of the auto-leveling sequence is to ensure that the wheels of the vehicle are always in contact with the ground. It is noted that the flowchart of FIG. 5 refers to operating two jacks in steps 204 and 206. In some cases, only one jack or a third jack may be operated, depending on the orientation of the vehicle. Thus, the controller may access a separate sensor that is operable to identify the overall orientation of the vehicle, such as if the entire vehicle is on a slight incline. The MCU can make a determination based on the vehicle orientation regarding the number of jacks to operate to reduce the pitch and roll angles to level.

If the MCU determines that the pitch and roll angles are within an acceptable range in steps 203, 205, then the MCU provides pressurized fluid to the extension pressure line 25 of all of the jacks A1-A4 to uniformly extend the associated piston rods until the ground-engaging plates P are all in contact the ground. Ground contact can be determined using the pressure transducer 28 or transducer array 28a, as described above. However, if the RV pitch and/or roll angles are outside the acceptable range, control passes to the steps 204, 206, as just described, followed by step 207 in which the jacks that were not previously operated are operated to bring their associated plates into ground contact. It can be appreciated in steps 204, 206, the MCU only activates the particular jack(s) necessary to reduce the pitch and/or roll angle of the RV. Once level is achieved the MCU can then extend the remaining jacks into ground contact in step 207. With the ground-engaging plates P of all of the jacks A1-A4 in ground contact, the MCU proceeds to steps 208-216, which are the same as steps 107-114 of the trailer leveling sequence of FIG. 4. When the user desires to drive the RV, the user requests retraction of the jacks in step 217, followed by the retraction of the jacks commanded by the MCU in step 218.

An auto-leveling sequence for a coach vehicle is shown in the flowchart of FIG. 6A. It can be appreciated that the initial steps in that sequence are the same as the steps 200-208 in the flowchart of FIG. 5. Steps 308, 310, 311 316 are the same as steps 208, 210, 211 and 216 according one leveling sequence for the coach. It is noted that for the coach, no determination is made as to whether there is any twist in the frame of the coach, so step 209 is not replicated in the flowchart of FIG. 6A. In an alternative embodiment, as shown in the flowchart of FIG. 6B, step 309 can be modified specifically to prevent twisting of the frame of the coach, without undertaking the sequence of steps 107-109 in the flowchart of FIG. 4. In this sequence of FIG. 6B, the MCU determines in step 311a whether the vehicle is level in the roll direction based on the data acquired in step 308. If not, then the MCU determines in step 311b whether the amount of tilt in the roll direction is greater at the front of the vehicle than at the back. The MCU then executes step 310a or 310b depending on which roll is greatest. In each step 310a, 310b the MCU determines whether the right side or the left side jack is to be operated to decrease the amount of roll, determines how long the identified jack is operated and then operates the identified jack accordingly. Thus, in each of the steps 310a, 310b, only one jack is operated at either the front or the back of the vehicle to reduce the roll to level. Control returns to step 308 to again measure the amount of tilt in the roll and pitch directions. Step 311c evaluates the amount of pitch and step 310c determines which pair of jacks—front or back—are operated, and for how long, to reduce the pitch. It is noted that once the roll direction has been resolved to level, raising the front or the back of the vehicle will not introduce any significant twist to the frame of the vehicle.

Each of the flowcharts in FIGS. 4-6B the vehicle or trailer includes an actuator at the four corners of the frame. However, some vehicles only include three actuators, with two actuators at the corners of one end of the frame and a third actuator in the middle of the opposite end of the frame. The MCU includes stored data indicative of the arrangement of actuators so that the MCU can determine which actuators to operate to reduce twist or tilt in the roll or pitch directions. With respect to twist, the third actuator is typically not operated since it does not ordinarily contribute the twisting the vehicle frame.

What is claimed is:

1. A method for automatically leveling a vehicle having a rectangular frame and at least three jacks, with one jack mounted at each corner on at least one end of the frame, each jack including a ground-engaging plate that is extended from a cylinder by a piston in the cylinder under fluid pressure on an extension pressure line and that can be retracted into the cylinder by fluid pressure on a retraction pressure line, the method comprising:
(a) determining if the frame is twisted by an amount exceeding a predetermined threshold;
(b) identifying which corner of the frame to raise to reduce the amount of twist in the frame;
(c) determining how much to raise the identified corner and determining the amount of time that pressurized fluid is applied to the extension pressure line of the jack at the identified corner of the frame to raise the corner by the determined amount and then operating the jack at the identified corner for the determined amount of time;
(d) repeating steps (a)-(c) until the amount of twist in the frame is below the threshold value;
(e) then measuring the amount of tilt in the pitch and roll directions of the frame;
(f) determining if the frame is level;
(g) if the amount of tilt in the pitch direction exceeds a predetermined amount, identifying which jack or jacks (jack(s)) of the at least three jacks to be operated to raise the front or the back of the trailer to reduce the amount of tilt in the pitch direction;
(h) determining how much to raise the front or the back of the trailer and determining the amount of time that pressurized fluid is applied to the extension pressure line of the identified jack(s) to raise the front or the back of the trailer by the determined amount, and then operating the identified jack(s) for the determined amount of time;
(i) if the amount of tilt in the roll direction exceeds a predetermined amount, identifying which jack or jacks (jack(s)) of the at least three jacks to be operated to raise the left or the right side of the trailer to reduce the amount of tilt in the roll direction;
(h) determining how much to raise the left or the right side of the trailer and determining the amount of time that pressurized fluid is applied to the extension pressure line of the identified jack(s) to raise the left or the right side of the trailer by the determined amount, and then operating the identified jack(s) for the determined amount of time; and
(i) repeating steps (f)-(h) until the frame is determined to be level.

2. The method of claim 1 in which the vehicle is a fifth-wheel trailer that is engaged to a towing vehicle by a trailer hitch arrangement, wherein, prior to step (a), the following steps are performed:
operating the jack or jacks (jack(s)) at the front of the trailer to extend the piston rod until the ground-engaging plates for the jack(s) contact the ground;
then operating the jack(s) for a predetermined time sufficient to further extend the piston rod to raise the front end of the trailer a sufficient distance to disengage the trailer from the towing vehicle at the trailer hitch arrangement;
then operating the jack(s) to retract the piston rod to thereby lower the front end of the trailer; and
then operating the jack(s) at the rear of the trailer to extend the associated piston rods until the associated ground-engaging plates contact the ground.

3. The method of claim 2, wherein:
prior to the step of operating the jack(s) to retract the piston rod to thereby lower the front end of the trailer, measuring the tilt in the pitch direction and storing the pitch measurement;
then when it is desired to re-engage the trailer to the towing vehicle at the trailer hitch arrangement, operating the jack(s) at the front of the trailer to raise the front end of the trailer until the pitch of the trailer equals the stored pitch measurement; and
then after the trailer is re-engaged to the towing vehicle at the trailer hitch, simultaneously operating all of the at least three jacks to retract the piston rods and move the associated ground-engaging plates out of contact with the ground.

4. The method of claim 1, in which the at least three jacks includes a pair of jacks mounted to the frame at an intermediate position along the length of the frame, and the method further comprises, after the trailer is determined to be level, the steps of:
measuring the fluid pressure in the cylinders of each jack at the opposite ends of the trailer;
calculating a pressure for the intermediate jacks based on distributing the total pressure of the jacks at the corners of the trailer among the jacks at the corners of the trailer and the intermediate jacks;
measuring the fluid pressure in the intermediate jacks; and
increasing the fluid pressure in the intermediate jacks until the pressure is within a predetermined range of the calculated pressure.

5. The method of claim 1, wherein prior to the step of determining the amount of twist in the frame, operating the jacks at the opposite ends of the frame until the ground-engaging plate for each jack is in contact with the ground.

6. The method of claim 5, wherein the step of operating the jacks includes:
measuring the amount of tilt in the pitch direction of the frame and operating either the front jack or jacks (jack(s)) or the rear jack(s) to reduce the amount of tilt in the pitch direction to within a predetermined threshold;
measuring the amount of tilt in the roll direction of the frame and operating either the left side jack(s) or the right side jack(s) to reduce the amount of tilt in the roll direction to within a predetermined threshold; and
operating any remaining jacks that are not already in contact with the ground to bring the ground-engaging plate for any remaining jack into contact with the ground.

7. An auto-leveling system for a vehicle, the vehicle having a rectangular frame comprising:
at least three jacks, with one jack on each corner of at least one end of the frame, each jack including a cylinder with a piston with a piston rod connected to a ground-engaging plate, the piston driven by fluid under pressure in an extension pressure line connected to the cylinder to extend the piston rod from the cylinder, and driven by fluid under pressure in a retraction pressure line to retract the piston rod into the cylinder;
a valve assembly connecting the extension pressure line and the retraction pressure line for each of the at least three jacks to a source of fluid under pressure and to a tank for receiving fluid from the extension pressure line and the retraction pressure line that is not under pressure, the valve assembly including;
a first directional valve movable to a first position in which the extension pressure line for all of the jacks is in fluid communication with the source of fluid under pressure and the retraction pressure line for all of the jacks is in direct fluid communication with the tank, and movable to a second position in which the extension pressure line for all of the jacks is in direct fluid communication with the tank and the retraction pressure line for all of the jacks is in direct fluid communication with the source of fluid under pressure;
a directional valve array interposed between the first directional valve and the extension pressure line for all of the jacks, the directional valve array including a directional valve corresponding to each of the at least three jacks, each directional valve movable to a first position in which the valve is closed to prevent fluid flow to the cylinder of the corresponding jack and a second position in which the valve is open to permit fluid flow to the cylinder of the corresponding jack;
wherein the first directional valve and each directional valve of the directional valve array is moved between the corresponding first and second positions by a solenoid; and
a pressure transducer interposed between the first directional valve and the extension pressure line for all of the at least three jacks; and
a controller including a microprocessor unit (MCU) configured and operable to receive a pressure signal from said pressure transducer and to control the solenoid of the first directional valve and the solenoid of each valve in the directional valve array to measure the pressure individually in each of the at least three jacks.

8. The auto-leveling system of claim 7, wherein:
the pressure transducer is interposed between the first directional valve and the directional valve array; and
the MCU is configured and operable to control the solenoid of each valve in the directional valve array to move only one valve to the second position in which the valve is open, with the other valves in the directional valve array in the first position in which the valve is closed.

9. The auto-leveling system of claim 7, further comprising:
a pitch sensor for continuously measuring the amount of tilt of the frame in the pitch direction; and
a roll sensor for continuously measuring the amount of tilt of the frame in the roll direction;
wherein the MCU receives data from the pitch and roll sensors and is configured and operable to;
use the data to determine the amount of twist in the frame; and
to successively operate one jack at a time to extend the one jack an amount to reduce the amount of twist in the frame until the amount of twist in the frame is within a predetermined threshold.

10. The auto-leveling system of claim 9, wherein the MCU is further configured and operable, after the amount of twist of the frame has been reduced to within the predetermined threshold, to;
use the data from the pitch sensor to determine the amount of tilt of the frame in the pitch direction and to determine which pair of jacks at the front end or the rear end of the trailer to operate to raise the respective front end or rear end to reduce the amount of tilt in the pitch direction to within a predetermined threshold; and
use the data from the roll sensor to determine the amount of tilt of the frame in the roll direction and to determine which pair of jacks at the right side and the left side of the trailer to operate to raise the respective right side and left side to reduce the amount of tilt in the roll direction to within a predetermined threshold.

11. A method for automatically leveling a vehicle having a rectangular frame and at least three jacks, with one jack mounted at each corner on at least one end of the frame, each jack including a ground-engaging plate that is extended from a cylinder by a piston in the cylinder under fluid pressure on an extension pressure line and that can be retracted into the cylinder by fluid pressure on a retraction pressure line, the method comprising
(a) measuring the amount of tilt in the pitch and roll directions of the frame;
(b) determining if the amount of tilt in the roll direction exceeds a predetermined threshold, and if so, then;
(b)(1) identifying whether the amount of tilt in the roll direction is greater at the front of the vehicle or at the back of the vehicle;
(b)(2)(i) if the amount of tilt is greater at the front of the vehicle, identifying which jack or jacks (jack(s)) at the front of the vehicle to operate and for how long to reduce the amount of tilt in the roll direction at the front of the vehicle, or
(b)(2)(ii) if the amount of tilt is greater at the rear of the vehicle, identifying which jack(s) at the rear of the vehicle to operate and for how long to reduce the amount of tilt in the roll direction at the rear of the vehicle, and operating the identified jack(s), and
repeating steps (a) and (b) until the amount of tilt in the roll direction is within the predetermined threshold;
(c) then determining if the amount of tilt in the pitch direction exceeds a predetermined threshold, and if so, then
(c)(1) determining whether to operate the jack(s) at the front or at the back of the vehicle to raise the front or the back of the vehicle to reduce the amount of tilt in the pitch direction and operating the identified jack(s); and
repeating steps (a) and (c) until the amount of tilt in the pitch direction is within the predetermined threshold.

12. A method for determining the weight of a vehicle having a rectangular frame and at least three jacks, with one jack mounted at each corner of at least one end of the frame, each jack including a ground-engaging plate that is extended from a cylinder by a piston in the cylinder under fluid pressure on an extension pressure line and that can be retracted into the cylinder by fluid pressure on a retraction pressure line, the method comprising:
operating the jack at each end of the frame until the associated ground-engaging plate is in contact with the ground;
operating the jack at each end for a predetermined amount of time sufficient to lift the vehicle off the ground;
measuring the fluid pressure in each jack; and
calculating the weight of the vehicle as the sum of the surface area of the ground-engaging plate for each jack multiplied by the measured fluid pressure for the associated jack.
